(19) United States
(12) Patent Application Publication
(10) Pub. No.: US 2012/0055433 A1
(43) Pub. Date: Mar. 8, 2012

(54) HIGH ENERGY IGNITION DISTRIBUTOR CAP

(75) Inventors: Jon A. Arotzarena, Parma, OH (US); Robert J. Frendak, North Royalton, OH (US); John M. Hrinsin, Avon Lake, OH (US); Timothy E. Musiek, Cleveland, OH (US)

(73) Assignee: PRESTOLITE WIRE, LLC, Cleveland, OH (US)

(21) Appl. No.: 12/874,418

(22) Filed: Sep. 2, 2010

(51) Int. Cl. F02P 7/00; H01S 4/00

(52) U.S. Cl. 123/146.5 A; 29/592.1

(57) ABSTRACT

Distributor caps, for example high energy ignition (HEI) distributor caps, may be configured to eliminate spark plug wire overlap via implementation of internal rewiring, for example rewiring corresponding to a firing order of a particular V-style engine. Individual tower terminals may be coupled to internal segments such that consecutive internal segments are coupled to consecutive tower terminals in the firing order, all tower terminals associated with cylinders on one side of the V-style engine are located on one side of the distributor cap, and all tower terminals associated with cylinders on the other side of the V-style engine are located on the other side of the distributor cap.

### TECHNICAL FIELD

The present disclosure relates to electrical systems, and in particular, to distributor caps for internal combustion engines.

### BACKGROUND

High energy ignition (HEI) systems, including associated distributor caps, are often preferred over point-type ignitions due to, for example, the ability to generate higher-voltage sparks and the corresponding ability to support wider spark plug gaps. HEI ignitions are often retrofitted to internal combustion engines configured with various other ignition systems, usually in an effort to improve engine performance. However, the HEI distributor cap may be configured such that external spark plug wires are routed to the appropriate spark plugs in a crisscrossing, “spaghetti”-like arrangement. Thus, it remains desirable to provide a HEI distributor cap configured to facilitate improved spark plug wire routing, among other things.

More particularly, prior distributor caps, for example distributor caps configured for use with vehicles manufactured by General Motors Corporation, suffer from various deficiencies. For example, many prior distributor caps are configured with tower terminals which require spark plug wires to criss-cross one another when routing to the respective spark plugs. Other distributor caps are configured with tower terminals which are not equally spaced, resulting in an undesirable aesthetic appearance. Yet other distributor caps are not direct replacements for prior distributor caps, requiring time-consuming and/or costly modification in order for use.

Even prior HEI distributor caps have been unable to overcome these difficulties. For example, certain prior HEI distributor caps have suffered from criss-crossing spark plug wires, where certain spark plug wires are routed over and/or under one another between the distributor cap and the respective spark plugs. Moreover, multiple spark plug wires may criss-cross one another. Still other HEI distributor caps are configured with non-symmetrical or other undesirable aesthetics of the tower terminals or other components.

### SUMMARY

This disclosure relates to systems and methods for distributor caps. In an exemplary embodiment, a distributor cap for a high energy ignition system for a V-style engine comprises a cap body, and a set of internal segments disposed within the cap body. Each of the internal segments is configured to electrically couple to the rotor of a distributor at successive rotational positions of the rotor. The distributor cap further comprises a set of tower terminals equally spaced about the cap body, each tower terminal coupled to one of the set of internal segments via a routing wire. Successive internal segments are coupled to successive tower terminals with respect to the firing order of the V-style engine. Each of the tower terminals is disposed on the cap body in a manner configured to permit routing of a spark plug wire between each of the tower terminals and each of the cylinders of the V-style engine to minimize crisscrossing of any spark plug wire.

In another exemplary embodiment, a method for creating a distributor cap for a V-style engine comprises forming, via a mold, a cap body, coupling a set of tower terminals to the cap body such that the tower terminals are equally spaced about the cap body, coupling a set of internal segments to a cap body, and coupling, via a plurality of routing wires, the set of tower terminals to the set of internal segments, such that each tower terminal is coupled to one internal segment, and each internal segment is coupled to one tower terminal. With respect to rotation of a rotor of a distributor for the V-style engine, successive internal segments are coupled to, with respect to a firing order of the V-style engine, successive tower terminals. With respect to the firing order of the V-style engine, all tower terminals corresponding to cylinders on one side of the V-style engine are located on one side of the distributor cap, and with respect to the firing order of the V-style engine, all tower terminals corresponding to cylinders on the opposite side of the V-style engine are located on the opposite side of the distributor cap.

The contents of this summary section are provided only as a simplified introduction to the disclosure, and are not intended to be used to limit the scope of the appended claims.

### BRIEF DESCRIPTION OF THE DRAWINGS

With reference to the following description, appended claims, and accompanying drawings:

FIG. 1 illustrates a block diagram of an exemplary HEI distributor cap in accordance with an exemplary embodiment;

FIG. 2A illustrates a perspective view of an exemplary HEI distributor cap in accordance with an exemplary embodiment;

FIG. 2B illustrates a bottom view of an exemplary HEI distributor cap in accordance with an exemplary embodiment;

FIG. 2C illustrates a perspective view of an exemplary HEI distributor cap configured with multiple tower terminal styles in accordance with an exemplary embodiment;

FIG. 3A illustrates a block diagram of cylinders in an exemplary internal combustion engine in accordance with an exemplary embodiment;

FIG. 3B illustrates internal wiring of an exemplary HEI distributor cap for use with the exemplary internal combustion engine of FIG. 3A in accordance with an exemplary embodiment;

FIG. 3C illustrates internal wiring of an exemplary HEI distributor cap in accordance with an exemplary embodiment;

FIG. 4 illustrates an exemplary HEI distributor cap coupled to an engine in a manner eliminating spark plug wire overlap in accordance with an exemplary embodiment; and

FIGS. 5A and 5B illustrate internal wiring of an exemplary HEI distributor cap in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for electrical and/or mechanical device construction, management, operation, measurement, optimization, and/or control, as well as conventional techniques for distributor and/or distributor cap configuration, construction, and use, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical distributor cap, for example a modified HEI distributor cap.

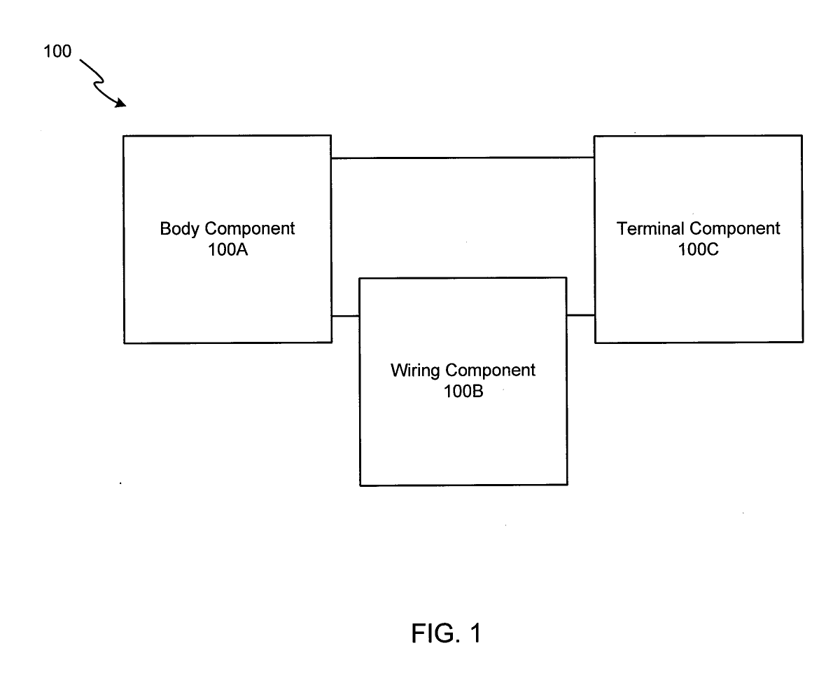

The present invention reduces and/or eliminates the problems with prior distributor caps by utilizing a HEI distributor cap configured in accordance with principles of the present disclosure. In accordance with an exemplary embodiment, and with reference to FIG. 1, a HEI distributor cap 100 comprises body component 100A, wiring component 100B, and terminal component 100C. Body component 100A can comprise molded thermoplastic, or mechanical components, structures, and/or materials configured to provide structural support to HEI distributor cap 100.

Wiring component 100B may comprise metal wire, or any other materials and/or structures configured to provide one or more electrical pathways through body component 100A, for example electrical pathways between the rotor of a distributor and one or more towers.

In one embodiment, terminal component 100C is coupled to wiring component 100B and to body component 10A. Terminal component 100C can comprise metal studs, prongs, inserts, towers, and/or any other suitable materials and/or structures configured to couple to external spark plug wires and to transfer electrical current thereto.

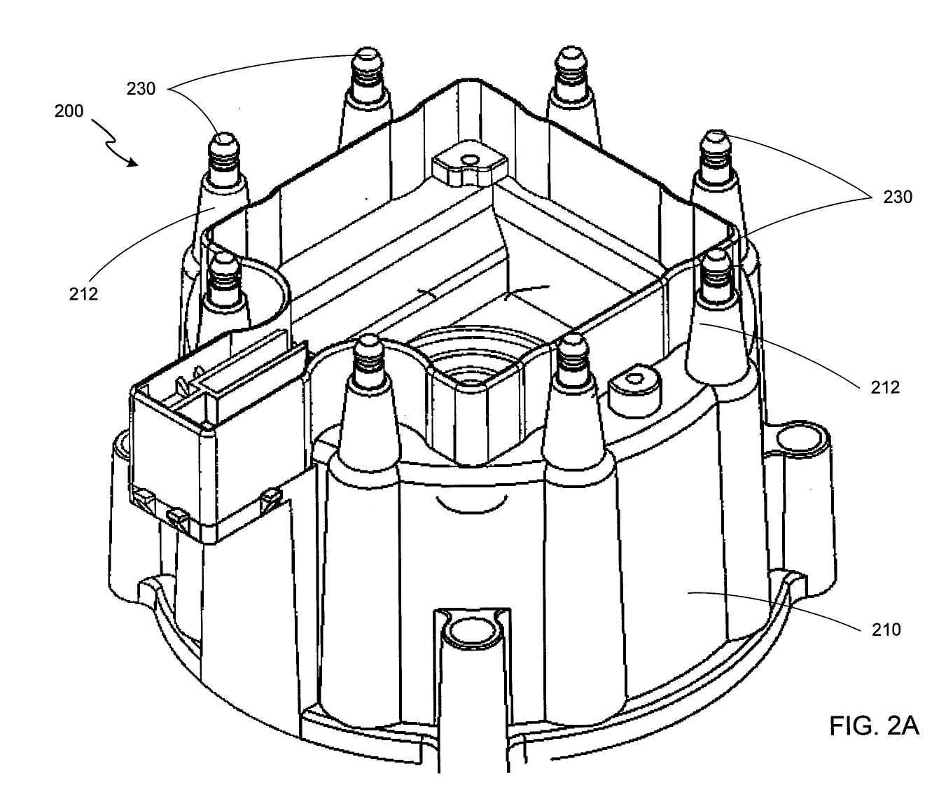

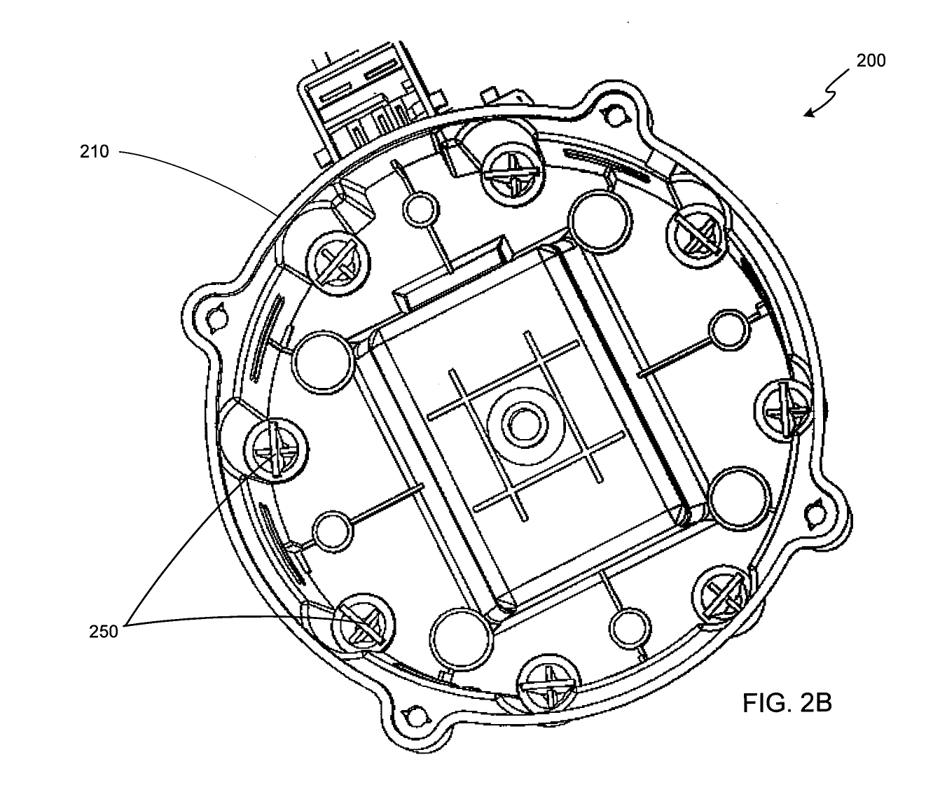

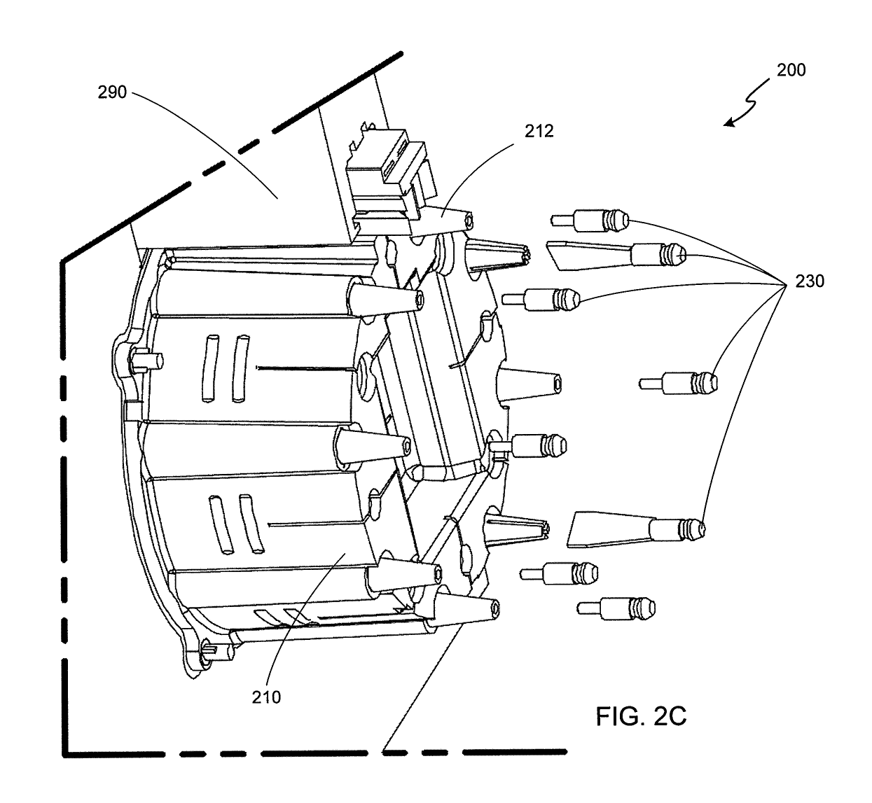

With reference now to FIGS. 2A-2C, in an exemplary embodiment, a HEI distributor cap 100 (for example, distributor cap 200) comprises body component 100A (for example, cap body 210), wiring component 100B (for example, routing wire 240), and terminal component 100C (for example, tower terminal 230). Distributor cap 200 is configured to couple to an internal combustion engine in order to distribute electrical current to the spark plugs thereof in a manner suitable for operation of the engine.

Cap body 210 may comprise any suitable materials, components, and/or elements configured to provide structural support to other components of HEI distributor cap 200. For example, cap body 210 may comprise thermoplastic, alkyd molding compound, polymers, composites, metal, and/or the like and/or combinations of the same. In an exemplary embodiment, cap body 210 may be formed by molding a desired shape from alkyd molding compound or other suitable material. In another exemplary embodiment, cap body 210 may be formed by machining material from a source block, for example via a mill. Cap body 210 may be monolithic. Alternatively, cap body 210 may comprise multiple components coupled together. Moreover, cap body 210 may be cast, pressed, sintered, die-cut, machined, stamped, bonded, laminated, polished, smoothed, bent, molded, plated, coated, and/or otherwise shaped and/or formed via any suitable method and/or apparatus.

In various exemplary embodiments, cap body 210 is configured to couple to, support, and/or otherwise interface with one or more tower terminals 230. The number of tower terminals 230 generally corresponds with the number of cylinders in the internal combustion engine with which distributor cap 200 is intended for use. In an exemplary embodiment, cap body 210 is configured to support 4 tower terminals 230. In another exemplary embodiment, cap body 210 is configured to support 6 tower terminals 230. In yet other exemplary embodiments, cap body 210 is configured to support 8 tower terminals 230. Moreover, cap body 210 may be configured to support any suitable number of tower terminals 230, as desired.

In an exemplary embodiment, cap body 210 is configured with one or more “towers” 212 extending therefrom and corresponding to each tower terminal 230. In this manner, cap body 210 is configured to provide appropriate clearance about each tower terminal 230 in order to couple a spark plug wire thereto. However, cap body 210 may be configured with any suitable extrusions, protrusions, extensions, flanges, angles, surfaces, trenches, holes, gaps, and/or the like, as suitable, in order to couple to tower terminals 230 and/or permit tower terminals 230 to couple to corresponding spark plug wires.

With continued reference to FIGS. 2A-2C, in various exemplary embodiments tower terminal 230 comprises electrically conductive material configured to transfer an electric current from within distributor cap 200 to an external spark plug via a spark plug wire. In an exemplary embodiment, tower terminal 230 is monolithic. In another exemplary embodiment, tower terminal 230 comprises a two-piece insert. In other exemplary embodiments, distributor cap 200 is configured with one or more monolithic tower terminals 230, and one or more two-piece insert tower terminals 230. For example, in an exemplary embodiment, distributor cap 200 is configured with two monolithic tower terminals 230 and six two-piece tower terminals 230. Moreover, distributor cap 200 may be configured with any suitable number, type, and/or configuration of tower terminals 230.

In various exemplary embodiments, tower terminals 230 are evenly distributed about the circumference of cap body 210. Stated another way, tower terminals 230 are generally separated by a center-to-center angular distance of about 360/X degrees with respect to a rotational axis of a distributor rotor corresponding to distributor cap 200, where X is the number of tower terminals 230. In one example, cap body 210 is configured to support 8 tower terminals 230, and each of the 8 tower terminals 230 is separated by a center-to-center angular distance of about 360/8 degrees=45 degrees.

In other exemplary embodiments, tower terminals 230 are unevenly distributed about cap body 210. In one example, 4 tower terminals 230 are located close together on one side of cap body 210, and 4 other tower terminals 230 are located close together on the opposite side of cap body 210. Moreover, tower terminals 230 may be located in any suitable location on cap body 210, as desired.

With particular reference now to FIG. 2B, in various exemplary embodiments distributor cap 200 is configured with internal segments 250. Each internal segment 250 is configured to electrically couple with a distributor rotor at a certain point in the rotation of the rotor, transferring an electric current to a particular tower terminal 230 coupled to internal segment 250. In contrast with various prior distributor caps, wherein internal segments 250 were coupled to the closest tower terminal 230, a distributor cap configured according to principles of the present disclosure may be configured with internal segments 250 coupled to various tower terminals 230 in order to achieve a desired firing order associated with tower terminals 230.

For example, distributor cap 200 is configured with a plurality of routing wires 240. Each routing wire 240 couples an internal segment 250 and a tower terminal 230. Routing wires 240 are configured such that tower terminals 230 are energized in a desired order responsive to rotation of the rotor of a distributor coupled to distributor cap 200.

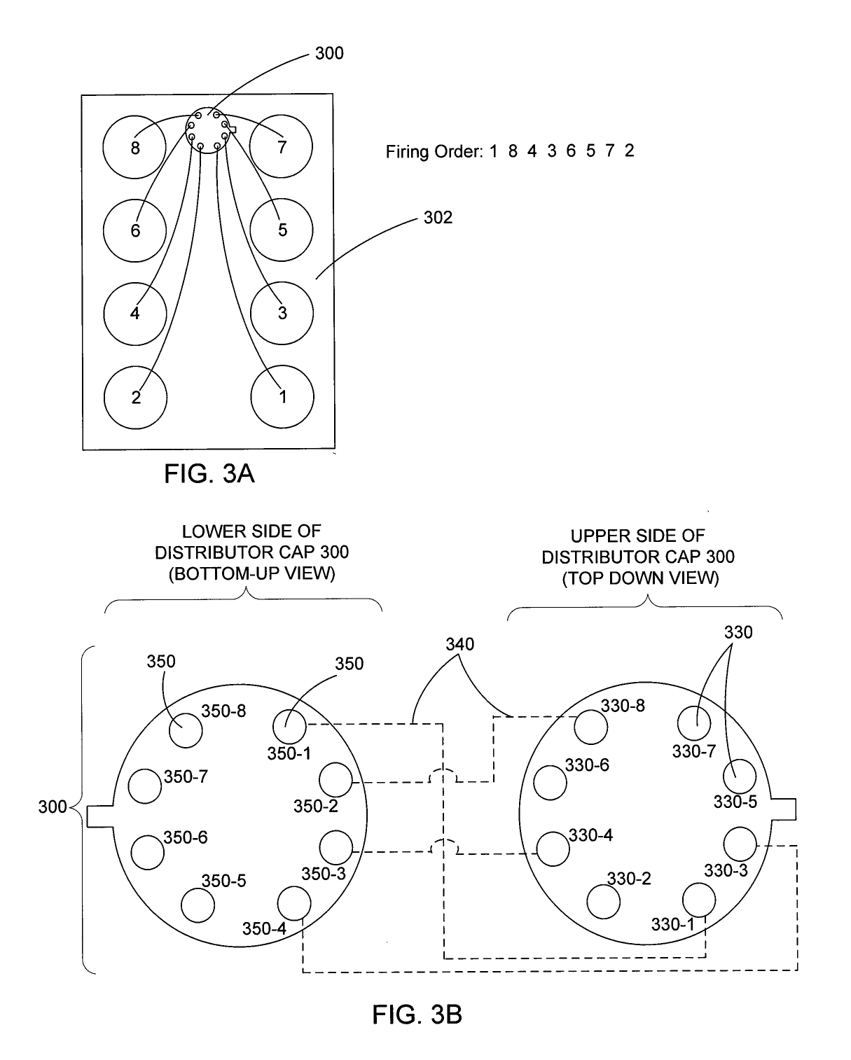

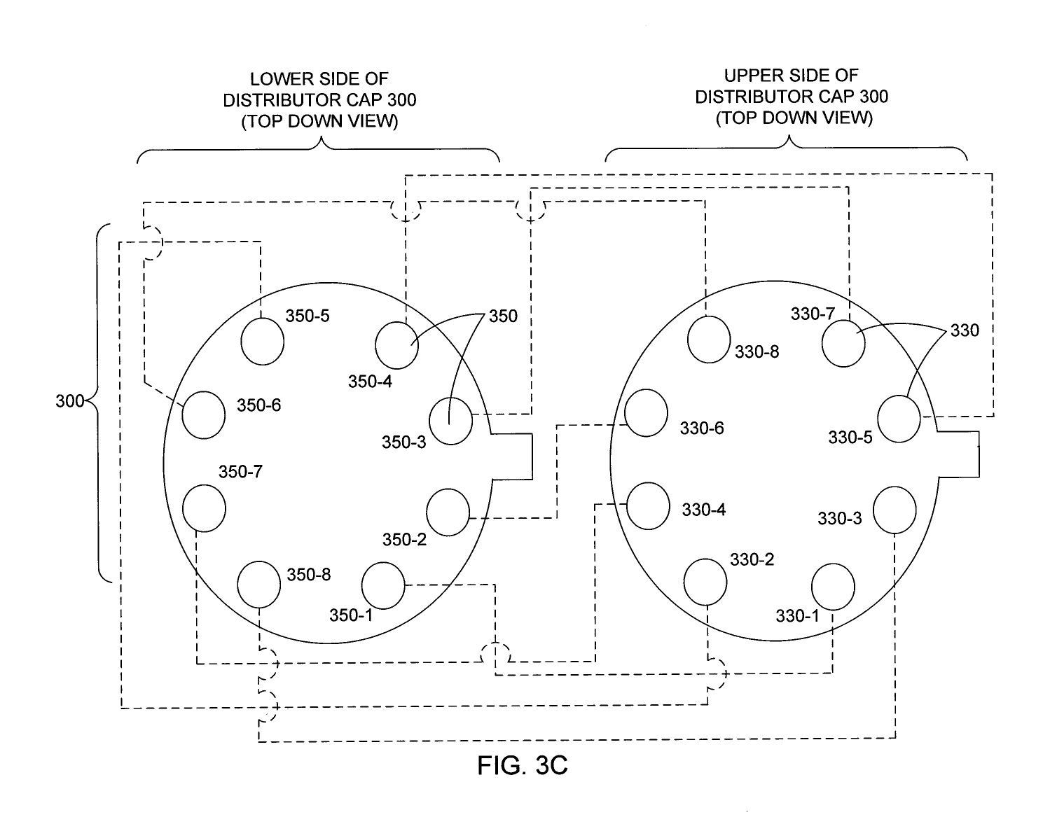

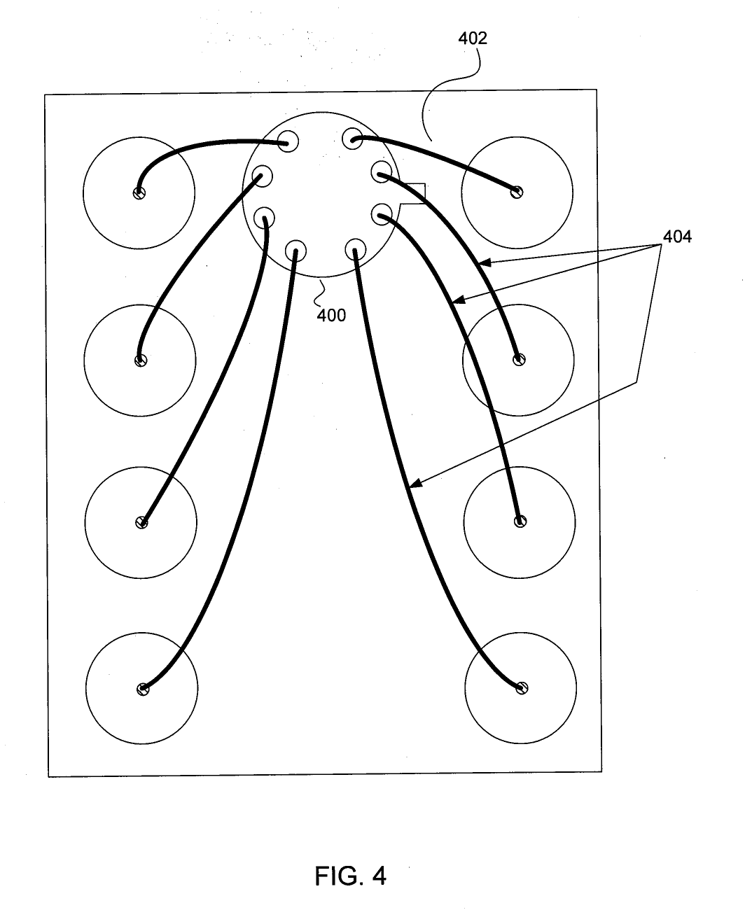

For example, with reference now to FIGS. 3A and 3B, a particular 8-cylinder internal combustion engine 302 is configured in a “V” configuration, with cylinders 1, 3, 5, and 7 on one side of engine 302, and cylinders 2, 4, 6, and 8 on an opposing side of engine 302. Engine 302 is configured with firing order “1 8 4 3 6 5 7 2”, indicating that engine 302 is configured for electrical current be delivered to the spark plug associated with cylinder 1, then the spark plug associated with cylinder 8, then the spark plug associated with cylinder 4, and so on.

In this exemplary embodiment, a distributor cap 300 configured in accordance with principles of the present disclosure may be configured with an “out of order” routing (with respect to rotation of a rotor of a distributor) between internal segments and tower terminals as follows. Distributor cap 300 is configured with a set of internal segments 350 (350-1 to 350-8) and a set of tower terminals 330 (330-1 to 330-8). Each internal segment 350 is coupled to a tower terminal 330 via a routing wire 340. Routing wires 340 coupled to successive internal segments 350 (with respect to rotation of the rotor of a distributor) are coupled, not to successive tower terminals 330 (with respect to rotation of the rotor of a distributor), but instead to successive tower terminals 330 with respect to the firing order of engine 302. Stated another way, the first internal segment 350-1 is coupled via a routing wire 340 to the tower terminal 330-1 associated with the first cylinder (cylinder 1) in the firing order, the second internal segment 350-2 is coupled via another routing wire 340 to the tower terminal 330-8 associated with the second cylinder (cylinder 8) in the firing order, the third internal segment 350-3 is coupled via yet another routing wire 240 to the tower terminal 330-4 associated with the third cylinder in the firing order, and so on. Further, tower terminals 330-1 through 330-8 are positioned on the exterior of distributor cap 300 in a manner corresponding to the respective cylinders of engine 302. Thus, spark plug wires coupling tower terminals 330 to the spark plugs associated with engine 302 may be directly routed thereto without external crossover.

In another exemplary embodiment, with reference now to FIG. 3C, distributor cap 300 may be configured with some internal segments 350 coupled to “out of order” tower terminals 330 (with respect to rotation of the rotor of a distributor) via routing wires 340, and some internal segments 350 coupled to corresponding tower terminals 330 with respect to rotation of the rotor of a distributor. In this exemplary embodiment, distributor cap 300 is configured with a set of internal segments 350 (350-1 to 350-8) and a set of tower terminals 330 (330-1 to 330-8). Each internal segment 350 is coupled to a tower terminal 330 via a routing wire 340. Tower terminals 330 are associated with respective cylinders 1-8 of a V-style engine having a cylinder numbering convention similar to that shown in FIG. 3A. Accordingly, even-numbered tower terminals (330-2, 330-4, etc.) are located on a first side of distributor cap 300, and odd-numbered tower terminals (330-1, 330-3, etc) are located on a second side of distributor cap 300 opposite the first side.

Routing wires 340 coupled to successive internal segments 350 (with respect to rotation of the rotor of a distributor) are coupled to successive tower terminals 330 with respect to the firing order of engine 302. However, this routing arrangement of routing wires 340 overlaps with a simple successive routing arrangement (with respect to rotation of a rotor of the distributor) at two locations, as follows:

350-1 is coupled to 330-1. At this point, the firing order routing overlaps with the simple successive routing. Stated another way, internal segment 350-1 is located at a similar angular position on distributor cap 300 as tower terminal 330-1; stated yet another way, internal segment 350-1 and tower terminal 330-1 may be considered to be coupled “in order.”

350-2 is coupled to 330-6.

350-3 is coupled to 330-7.

350-4 is coupled to 330-5.

350-5 is coupled to 330-2.

350-6 is coupled to 330-8.

350-7 is coupled to 330-4. At this point, the firing order routing again overlaps with the simple successive routing. Stated another way, internal segment 350-7 is located at a similar angular position on distributor cap 300 as tower terminal 330-4; stated yet another way, internal segment 350-7 and tower terminal 330-4 may be considered to be coupled “in order.”

350-8 is coupled to 330-3.

Stated generally, in accordance with principles of the present disclosure, internal segments 350 may be coupled to tower terminals 330 via routing wires 340 in any suitable manner and/or arrangement configured to eliminate crossover of spark plug wires coupling distributor 300 to an engine. Moreover, various engine firing orders may be accommodated by revising the couplings between tower terminals 330 and internal segments 350, as suitable.

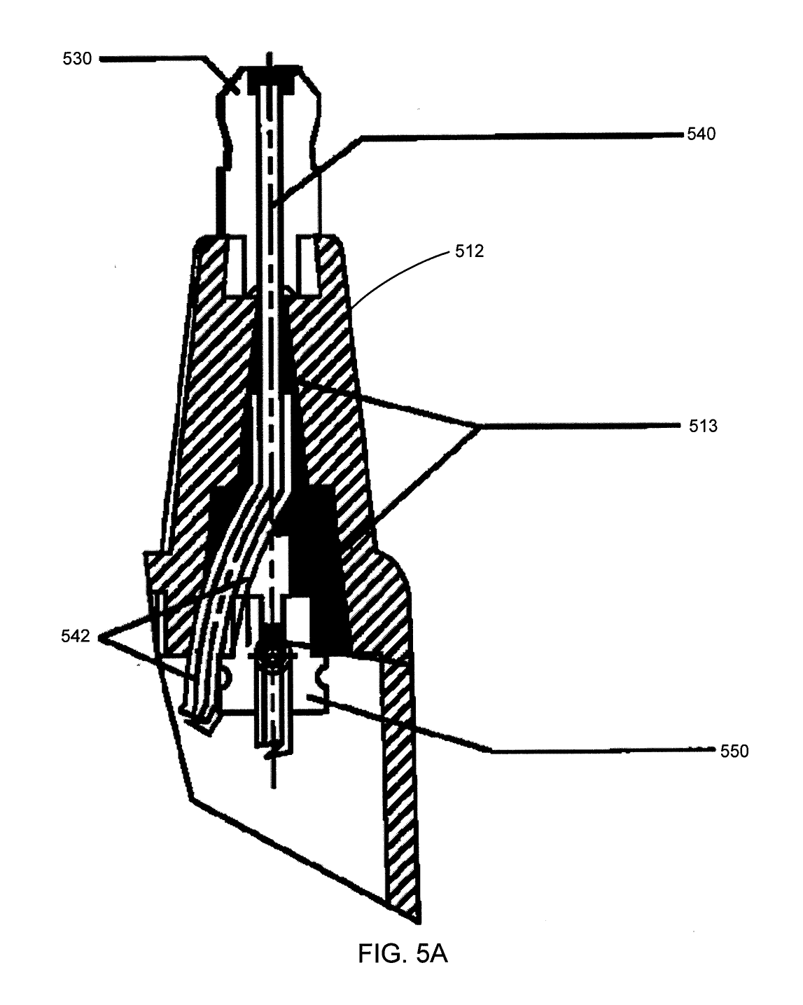

Turning now to FIG. 4, in an exemplary embodiment a distributor cap 400 is coupled to an engine 402 via a plurality of spark plug wires 404. Because distributor cap 400 implements a firing order-based routing configuration between internal segments and tower terminals in accordance with principles of the present disclosure, spark plug wires 404 can be routed directly to the corresponding cylinders without (or with reduced) criss-crossing of the wires. Stated another way, spark plug wires 404 are routed to the corresponding cylinders without (or with a reduced amount of) passing over and/or under any other spark plug wire 404 between distributor cap 400 and the corresponding cylinders. In this manner, shorter spark plug wires may be utilized, potentially improving engine performance due to reduced resistive losses in the wire. Additionally, unsightly spark plug wire overlap can be eliminated, resulting in improved aesthetic appearance of the engine.

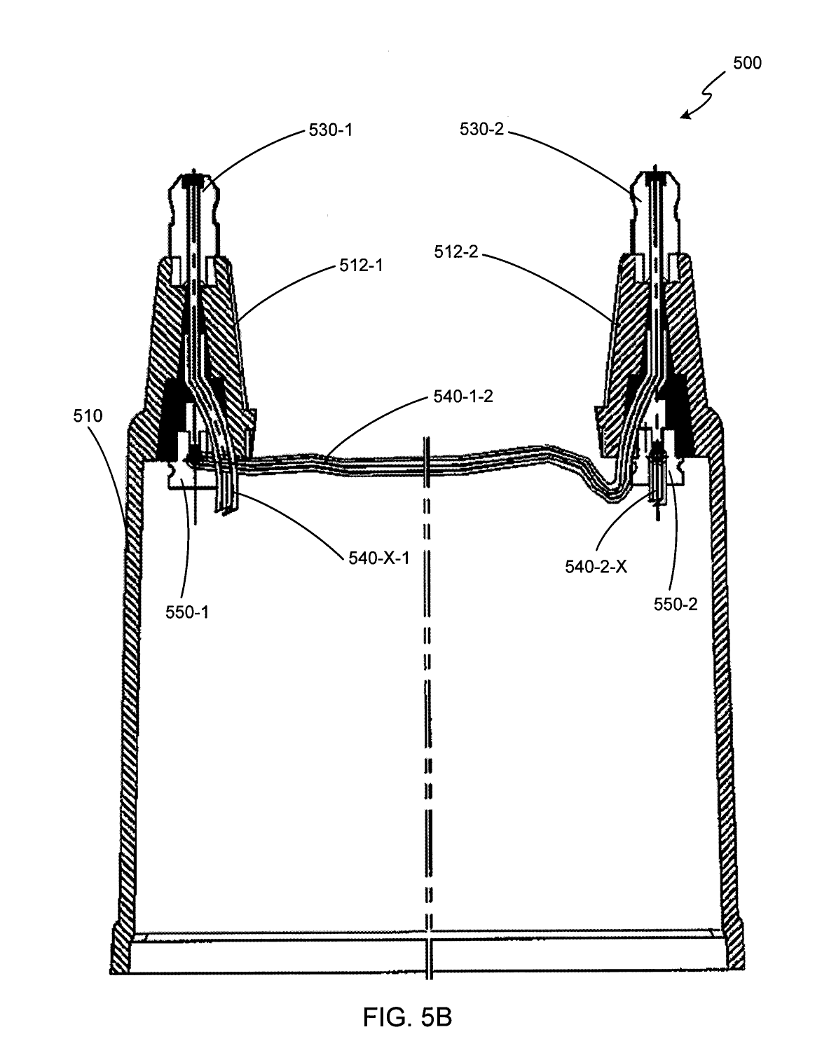

With reference now to FIGS. 5A and 5B, in various exemplary embodiments a distributor cap 500 is configured with towers 512 having internal segments 550 disposed therebelow, and tower terminals 530 disposed thereon. However, certain tower terminals 530 are not coupled to internal segments 550 below the corresponding tower 512, but rather to a different internal segment 550 in order to implement a firing-order based configuration. Tower terminals 530 are coupled to internal segments 550 via routing wire 540, which may be at least partially surrounded by insulation 542. Moreover, towers 512 may comprise and/or at least partially be filled with epoxy or other insulating material, for example in order to prevent tower terminals 530 from contacting internal segments 550 through towers 512.

With particular reference now to FIG. 5B, in an exemplary embodiment towers 512-1 and 512-2 are disposed adjacent to one another on cap body 510. Internal segment 550-1 is coupled via routing wire 540-1-2, not to tower terminal 530-1, but to tower terminal 530-2 in order to implement a firing-order based configuration. Similarly, tower terminal 530-1 is coupled to an internal segment 550 (not shown in FIG. 5B) via routing wire 540-X-1, and internal segment 550-2 is coupled to a tower terminal 530 (not shown in FIG. 5B) via routing wire 540-2-X, in order to implement a firing-order based configuration. In certain exemplary embodiments, routing wires 540-1-2, 540-X-1, 540-2-X, and all other routing wires 540 within distributor cap 500 are coupled to suitable internal segments 550 and tower terminals 530 prior to molding of cap body 510 therearound. In other exemplary embodiments, routing wires 540 within distributor cap 500 are coupled to suitable internal segments 550 and tower terminals 530 after cap body 510 has been formed, for example by placing routing wires 540 in one or more of channels, trenches, cavities, guide loops, and/or other portions of cap body 510 intended to receive routing wires 540. In this manner, distributor cap 500 may be configured to implement a firing-order based configuration.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A distributor cap for a high energy ignition system for a V-style engine, the distributor cap comprising:
a cap body;
a set of internal segments disposed within the cap body, each of the internal segments configured to electrically couple to the rotor of a distributor at successive rotational positions of the rotor; and
a set of tower terminals equally spaced about the cap body, each tower terminal coupled to one of the set of internal segments via a routing wire;
wherein successive internal segments are coupled to successive tower terminals with respect to the firing order of the V-style engine, and
wherein each of the tower terminals is disposed on the cap body in a manner configured to permit routing of a spark plug wire between each of the tower terminals and each of the cylinders of the V-style engine to minimize crisscrossing of any spark plug wire.

2. The distributor cap of claim 1, wherein each of the tower terminals is disposed on the cap body in a manner configured to permit routing of a spark plug wire between each of the tower terminals and each of the cylinders of the V-style engine to eliminate crisscrossing of any spark plug wire.

3. The distributor cap of claim 2, wherein at least two of the tower terminals are coupled to corresponding internal segments with respect to rotation of a rotor of a distributor for the V-style engine.

4. The distributor cap of claim 2, wherein the distributor cap is a direct replacement for a stock distributor cap.

5. The distributor cap of claim 2, wherein, with respect to the firing order of the V-style engine, all tower terminals corresponding to cylinders on one side of the V-style engine are located on one side of the distributor cap, and wherein, with respect to the firing order of the V-style engine, all tower terminals corresponding to cylinders on the opposite side of the V-style engine are located on the opposite side of the distributor cap.

6. The distributor cap of claim 2, wherein each of the routing wires is molded into the cap body.

7. The distributor cap of claim 2, wherein at least one of the routing wires and at least one of the set of tower terminals together comprise a single piece of electrically conductive material.

8. A method for creating a distributor cap for a V-style engine, the method comprising:
forming, via a mold, a cap body;
coupling a set of tower terminals to the cap body such that the tower terminals are equally spaced about the cap body;
coupling a set of internal segments to a cap body; and
coupling, via a plurality of routing wires, the set of tower terminals to the set of internal segments, such that each tower terminal is coupled to one internal segment, and each internal segment is coupled to one tower terminal;
wherein, with respect to rotation of a rotor of a distributor for the V-style engine, successive internal segments are coupled to, with respect to a firing order of the V-style engine, successive tower terminals, and
wherein, with respect to the firing order of the V-style engine, all tower terminals corresponding to cylinders on one side of the V-style engine are located on one side of the distributor cap, and
wherein, with respect to the firing order of the V-style engine, all tower terminals corresponding to cylinders on the opposite side of the V-style engine are located on the opposite side of the distributor cap.

9. The method of claim 8, wherein the distributor cap is a HEI distributor cap.

10. The method of claim 9, further comprising coupling, via a plurality of spark plug wires, the tower terminals of the distributor cap to spark plugs of the V-style engine, such that no spark plug wire criss-crosses any other spark plug wire.

11. The method of claim 8, wherein the plurality of routing wires are molded into the cap body.
